(19) United States
(12) Patent Application Publication
(10) Pub. No.: US 2006/0186625 A1
(43) Pub. Date: Aug. 24, 2006

(54) Baggage cart drawbar assembly

(76) Inventors: Eric M. Terpsma, Holland, MI (US); Roger L. Jansen III, Holland, MI (US); Daniel A. Bennett, Holland, MI (US); Richard T. Polanic, Hudsonville, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/357,530

(22) Filed: Feb. 17, 2006

Related U.S. Application Data
(60) Provisional application No. 60/655,071, filed on Feb. 22, 2005.

(51) Int. Cl. B62B 3/00

(52) U.S. Cl. 280/47.35

(57) ABSTRACT

A drawbar assembly for a baggage cart that comprises a pair of bar members spaced apart from one another and having a first end pivotally coupled to a cart, and a second end, and a mounting member fixedly coupled between the bar members proximate the second end of the bar members, wherein the mounting member includes an aperture extending therethrough. The drawbar assembly further includes a coupling member having an eyelet and a threaded stud extending from the eyelet and received within the aperture of the mounting member, a seal member positioned between the eyelet and the mounting member, and a nut threadably received on the stud and fastening the coupling member to the mounting member, such that the stud of the coupling member is rotatable within the aperture of the mounting member.

### CROSS REFERENCE TO RELATED APPLICATION

This application claims the benefit of U.S. Provisional Application No. 60/655,071, filed Feb. 22, 2005, entitled BAGGAGE CART DRAWBAR ASSEMBLY, which is hereby incorporated herein by reference in its entirety.

### BACKGROUND OF THE INVENTION

The present invention relates to a drawbar assembly for a baggage cart, and in particular to a drawbar assembly adapted to prevent structural damage to the associated baggage cart and towing vehicle, as well as the drawbar assembly, should a roll-over accident of the baggage cart occur.

Drawbars are used in a wide variety of applications, such as for towing farm implements, heavy-duty construction equipment, highway trailers, as well as within specialty applications such as with baggage carts and the like. With respect to the particular application of utilizing a drawbar for towing a baggage cart at an airport, these drawbars typically comprise a heavy-duty construction, wherein the main portion of the drawbar is a solid steel member pivotally fixed at a first end to an associated baggage cart to allow lifting of the drawbar with respect to the baggage cart, and at a second end to an associated towing vehicle via a drop pin assembly. Each component of these drawbars are typically welded into a single integral piece, thereby resulting in severe damage to the baggage cart, the towing vehicle, and/or the drawbar assembly should a roll-over accident of the baggage cart occur.

Other drawbar arrangements have been designed in order to minimize the damage to the baggage cart, the towing vehicle and/or the drawbar by constructing the drawbar from a plurality of telescopingly-engaged cylindrical tubes which are in turn coupled to one another via bolts that extend through overlapping sections of the tubes. During operation, should a roll-over accident of the baggage cart occur, the bolts extending through the tubular sections of the drawbar are sheared, thereby allowing an end of the drawbar coupled to the baggage cart to pivot independently of an end of the drawbar coupled to the towing vehicle. However, the sheared parts of the bolts result in debris being released within the operational area of aircraft, thereby increasing the likelihood of damage to the aircraft by puncturing the tires thereof, and/or by ingestion into the engines.

A drawbar assembly for a baggage cart is desired that reduces the likelihood of damage to a baggage cart, a towing vehicle, and/or the drawbar assembly itself during a roll-over accident of the baggage cart, while simultaneously eliminating the possibility of debris from the drawbar assembly from being left within aircraft operational areas due to the rollover of the cart and damage to the drawbar. Further, a drawbar assembly is desired that reduces the relative weight thereof, optimizes the handling and lifting thereof, and minimizes the components required in order to safely operate the associated baggage cart.

### SUMMARY OF THE INVENTION

One aspect of the present invention is to provide a baggage cart assembly comprising a cart including a plurality of wheels, an interior compartment, and a drawbar assembly. The drawbar assembly comprises a pair of bar members spaced apart from one another and each having a first end pivotally coupled to the cart and a second end, a mounting member fixedly coupled between the pair of bar members proximate the second end of the bar members, wherein the mounting member has an aperture extending therethrough, and a coupling member having an eyelet and a threaded stud extending from the eyelet and received within the aperture of the mounting member. The drawbar assembly further includes an at least one seal member positioned between the eyelet of the coupling member and the mounting member, and a nut threadably received on the stud of the coupling member and fastening the coupling member to the mounting member, such that the stud of the coupling member is rotatable within the aperture of the mounting member.

Another aspect of the present invention is to provide a drawbar assembly for moving a baggage cart within a vehicle, wherein the drawbar assembly comprises a drawbar member having a first end adapted to be operably coupled to a cart, and a second end, and a mounting member fixedly coupled to the second end of the drawbar. The drawbar assembly further includes a coupling member having a first end pivotally coupled to the mounting member and a second end adapted to couple to a vehicle, wherein the coupler member is pivotable with respect to the mounting member when a given amount of torque is applied to at least a select one of the bar members and the coupler member, thereby preventing damage to the drawbar assembly during roll-over of a coupled cart.

The present inventive drawbar assembly for a baggage cart reduces the likelihood of damage to a baggage cart, a towing vehicle, and/or the drawbar assembly itself during a roll-over accident of the baggage cart, while simultaneously eliminating the possibility of debris from the drawbar assembly from being left within aircraft operational areas due to the rollover of the cart and damage to the drawbar. Further, the present inventive design also permits the drawbar eye to be “reset” after a rollover and returned to service with minimal cost and effort. Moreover, the drawbar assembly, reduces the relative weight thereof, optimizes the handling and lifting thereof, minimizes the components required in order to safely operate the associated baggage cart, is capable of a long-operating life, and is particularly well adapted for the intended use.

These and other advantages of the invention will be further understood and appreciated by those skilled in the art by reference to the following written specification, claims and appended drawings.

### BRIEF DESCRIPTION OF THE DRAWINGS

FIG. 1 is a perspective view of a drawbar assembly embodying the present invention and coupling a baggage cart to a towing vehicle;

FIG. 2 is a perspective view of the drawbar assembly;

FIG. 3 is a top view of the drawbar assembly;

FIG. 4 is a side view of the drawbar assembly;

FIG. 5 is a perspective view of an alternative embodiment bar member of the drawbar assembly;

FIG. 6 is a perspective view of a mounting member of the alternative embodiment of the drawbar assembly;

FIG. 7 is a side and rear perspective view of the alternative locking mechanism; and

FIG. 8 is a bottom view of the alternative locking mechanism.

### DETAILED DESCRIPTION OF THE PREFERRED EMBODIMENTS

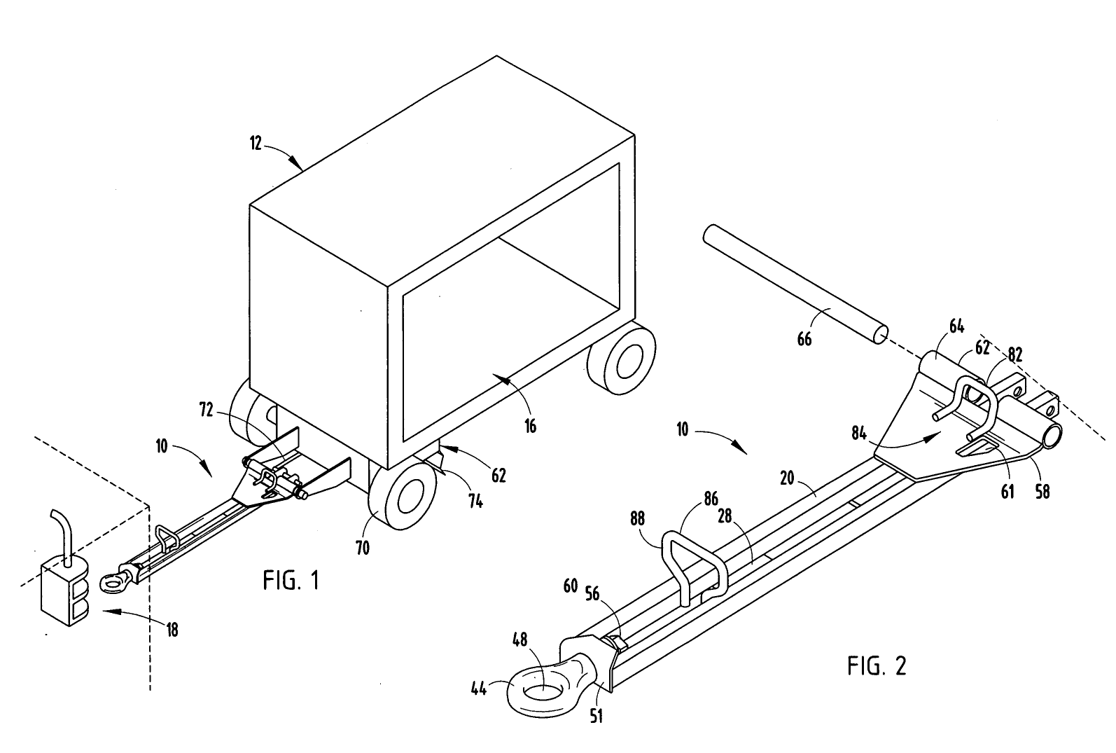

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

The reference numeral 10 (FIG. 1) generally designates a drawbar assembly coupling an associated baggage cart 12 to a towing vehicle 14. In the illustrated example, the baggage cart 12 includes an interior space 16 adapted to receive baggage and packages therein, and the towing vehicle comprises another baggage cart, however, other towing vehicles, such as tow tractors, may be utilized. Further, it should be noted that while the illustrated example incorporates a baggage cart 12, other towed cart, vehicle, and the like may also be used in combination with the present inventive drawbar assembly 10. The drawbar assembly 10 is operably coupled to the towing vehicle 14 by a spring loaded drop-pin type assembly 18 as is known in the art, however, other hitching assemblies known in the art may also be utilized.

The drawbar assembly 10 (FIGS. 2-4) includes a pair of longitudinally-extending bar members 20, each having a first end 22 pivotably coupled to the baggage cart 12, and a second end 24 operable coupled to the towing vehicle. Each bar member 20 is provided with a hollow interior 26 and a rectangularly-shaped cross-sectional configuration. Each of the bar members 20 is welded to a pair of spacer members 28 spaced along the length of the bar members 20, and a mounting member 30 located proximate the second end 24 of the bar members 20. The mounting member 30 is provided a rectangular box shape and includes a rear surface 36 and a centrally-located bore or aperture 38 extending therethrough. In assembly, the bar members 20 abut opposite sides of the mounting member 30 and are securely fixed thereto via welding.

The drawbar assembly 10 further includes a coupling member 44 pivotally secured to the mounting member 30. In the illustrated example, the coupling member 44 includes an eyelet 46 having an aperture 48 extending therethrough for receiving a drop pin therein, and a threaded stud 50 extending outwardly from the eyelet 46. A radially-extending compression wall 52 is located between the eyelet 46 and the stud 50. The drawbar assembly 10 further includes an end plate 51 wrapping about an end of each of the bar members 20 and the mounting member 30. In assembly, a first pair of sealing washers 41 are located about the stud 50 of the coupling member, and the stud 50 is then positioned within the aperture 38 of the mounting member 30. A nut 56 is then threaded onto the stud 50 after locating a second pair of sealing washers 43 about the stud 50 such that the washers 43 are located between the nut 56 and the rear surface 36 of the mounting member 30. The frictional force exerted by the first pair of washers 41, between the end plate 51 and the compression wall 52 of the coupler member 44 is adjusted by changing the threaded position of the nut 56 along the stud 50. This adjustment allows the amount of force required to turn the eyelet 36 with respect to the bar member 20 to be set to a predetermined amount. A tack weld (not shown) is then applied between the nut 56 and the stud 50 to prevent adjustment of the nut 50 subsequent to assembly. The first and second pairs of washers 41, 43 operate to prevent debris from entering the aperture 38 of the mounting member 30.

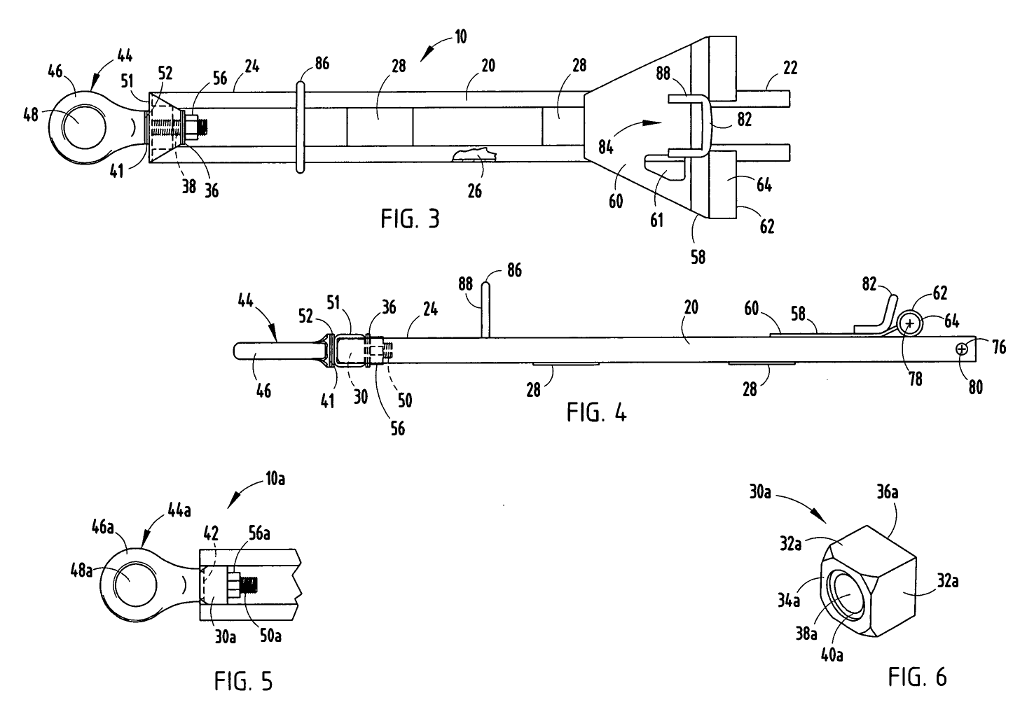

Alternatively, the first and second pairs of washers 41, 43 (FIG. 3) are replaced by an O-ring 42 (FIG. 5). The reference numeral 10a generally designates an alternative embodiment of the drawbar assembly. Since the drawbar assembly 10a is similar to the drawbar assembly 10, similar elements in FIG. 3 and FIG. 5 are represented by the same reference numeral respectfully, except for the suffix “a” used within the latter. The drawbar assembly 10a includes a mounting member 30a (FIG. 6) having a plurality of planar sides 32a, a front surface 34a, a rear surface 36a, and a centrally-located bore or aperture 38a extending therethrough. The aperture 38a is concentrically surrounded by a step channel 40a that receives the compressible O-ring 42 therein. In assembly, the O-ring 42 is located about the stud 50a of the coupling member 44a, and the stud 50a is then positioned within the aperture 38a of the mounting member 30a. The nut 56a is then threaded onto the stud 50a and abuts the rear surface 36a of the mounting member 30a, thereby compresses the O-ring 42 within the channel 40a and between the mounting member 30a and the compression wall 52a of the coupling member 44. The compression of the O-ring 42 and the frictional force exerted by the O-ring 42 between the mounting member 30a and the compression wall 52a of the coupler member 44a is adjusted by changing the threaded position of the nut 56a along the stud 50a. This adjustment allows the amount of force required to turn the eyelet 36a with respect to the bar member 20a to be set to a predetermined amount. The O-ring 42 operates to prevent debris from entering the aperture 38a of the mounting member 30a. In the illustrated example, the O-ring 42 is seated within the channel 40a of the mounting member 30a, thereby reducing ultraviolet degradation to the O-ring 42. It should be noted that the second end 24a of each bar member 20a of the alternative drawbar assembly 10a includes a welding aperture 54a extending therethrough, thereby increasing the strength of the weld between the mounting member 30a and the bar members 20a.

The drawbar assembly 10 (FIGS. 2-4) further includes a hinge member 58 having a mounting plate 60 having an offset window 61 extending therethrough, and weldably secured to an upper surface of each of the bar members 20, and a hinge 62. In the illustrated example, the hinge 62 includes three spaced-apart tubular members 64 that receive a pivot pin 66 therein, wherein two of the tubular members 64 are securely affixed to the mounting plate 60, and a third tubular member (not shown) is secured to a portion of the baggage cart 12. The pivot pin 66 extends through each of the tubes, thereby forming a piano-type hinge.

The baggage cart 12 includes a braking system 68 (schematically represented in FIG. 1) that is adapted to abut the wheels 70 of the baggage cart 12 in a manner known in the art. The braking system 68 includes an actuator arm 72 operably coupled to a wheel chalk 74 that abuts the wheels 70 of the baggage cart 12 when actuated. The illustrated example, each of the bar members 20 includes an aperture 76 extending through the first end 24 thereof. Each of the apertures 76 receives an end of the actuator arm 72 therein. It should be noted that the pivot axis 78 of the pivot pin 66 and the pivot axis 80 of the apertures 76 are longitudinally and vertically offset from one another. As a result, upward movement of the bar member 20 with respect to the cart 12 actuates the braking system 68 and causes the chalks 74 to abut the wheel 70 of the baggage cart 12.

The drawbar assembly 10 further includes a locking mechanism 82 weldably secured to an upper surface of the mounting plate 60. The locking mechanism 82 provides an aperture 84 into which a locking member (not shown) is received, thereby releasably securing the drawbar assembly 10 in a raised storage position.

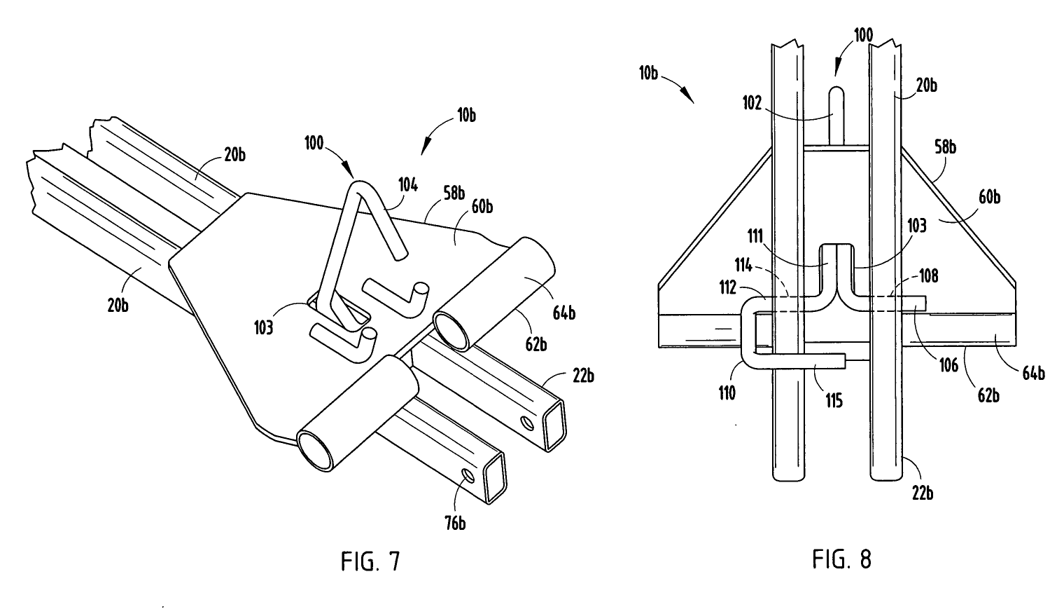

The reference numeral 10b (FIGS. 7 and 8) represents another alternative embodiment of the drawbar assembly. As the drawbar assembly 10b and the drawbar assembly 10 are similar in construction, like elements in FIGS. 2-4 and FIGS. 7 and 8 are represented by the same reference numerals except from the suffix “b” in the latter. The drawbar assembly 10b includes an alternative locking mechanism 100 having an arm 102 extending through a slot 103 located within the mounting plate 60b, and having a hook-shaped first end 104 and an L-shaped second end 106 pivotably located within an aperture 108 extending through one of the bars 20b. The locking mechanism 100 further includes a C-shaped pivot member 110 having a leg 111 welded to the arm 102, a first portion 112 pivotably received within an aperture 114 extending through the remaining bar 20b, and a second portion 115 extending below the bar 20b and positioned so as to limit the pivoting travel of the locking mechanism 100 with respect to the bars 20b. When the drawbar assembly 10b is in use, the arm 102 is rotated to be flush against the mounting plate 60b, and such that the second portion 115 of the pivot member 110 abuts an underside of one of the bars 20b. When the drawbar assembly 10b is in storage, the first end 104 of the arm 102 engages or “hooks” a component associated or fixed to the cart 12, thereby retaining the drawbar assembly 10b in the raised, storage position.

A handle 86 (FIGS. 2-4) having an outwardly-flared upper portion 88 is weldably secured to the bar members 20 approximately one quarter of the distance along the length of the bar members from the second end 24 thereof. The placement of the handle 86 at this location provides a reduced lifting moment of the drawbar assembly about the pivot point 78, thereby allowing easier lifting and manipulation of the drawbar assembly 10.

The present inventive drawbar assembly for a baggage cart reduces the likelihood of damage to a baggage cart, a towing vehicle, and/or the drawbar assembly itself during a roll-over accident of the baggage cart, while simultaneously eliminating the possibility of debris from the drawbar assembly from being left within aircraft operational areas due to the rollover of the cart and damage to the drawbar. Further, the drawbar assembly, reduces the relative weight thereof, optimizes the handling and lifting thereof, minimizes the components required in order to safely operate the associated baggage cart, is capable of a long-operating life, and is particularly well adapted for the intended use.

In the foregoing description, it will be readily appreciated by those skilled in the art that modifications may be made to the invention without departing from the concepts disclosed herein. Such modifications are to be considered as included in the following claims, unless these claims by their language expressly state otherwise.

The invention claimed is:

1. A baggage cart assembly, comprising:
a cart including a plurality of wheels and an interior compartment; and
a drawbar assembly, comprising:
a pair of bar members spaced apart from one another and each having a first end pivotably coupled to the cart, and a second end;
a mounting member fixedly coupled between the pair of bar members proximate the second end of the bar members, the mounting member having an aperture extending therethrough;
a coupling member having an eyelet and a threaded stud extending from the eyelet and received within the aperture of the mounting member;
at least one seal member positioned between the eyelet of the coupling member and the mounting member; and
a nut threadably received on the stud of the coupling member and fastening the coupling member to the mounting member, such that the stud of the coupling member is rotatable within the aperture of the mounting member.

2. The baggage cart assembly of claim 1, wherein the drawbar assembly further includes a handle member extending upwardly from the bar members.

3. The baggage cart assembly of claim 1, wherein the cart further includes a brake system having an actuator arm, and wherein at least one of the pair of bar members includes an aperture extending therethrough that receives the actuator arm.

4. The baggage cart assembly of claim 3, wherein the first end of the pair of bar members pivot about a pivot axis, and wherein the pivot axis is located upwardly and forwardly of the aperture of the pair of bar members that receives the actuator arm of the brake system.

5. The baggage cart assembly of claim 1, wherein the first end of the pair of bar members is pivotably coupled to the cart by a piano hinge.

6. The baggage cart assembly of claim 1, wherein the at least one seal member comprises a pair of washers.

7. A drawbar assembly for moving a baggage cart with a vehicle, comprising:
a drawbar member having a first end adapted to be operably coupled to a cart, and a second end;
a mounting member fixedly coupled to the second end of the drawbar;
a coupler member having a first end pivotably coupled to the mounting member and a second end adapted to couple with a vehicle, wherein the coupler member is pivotable with respect to the mounting member when a given amount of torque is applied to at least a select one of the bar member and the coupler member, thereby preventing damage to the drawbar assembly during roll-over of a coupled cart.

8. The drawbar assembly of claim 7, wherein the coupler member includes a stud that is received within an aperture of the mounting member.

9. The drawbar assembly of claim 8, wherein the stud of the coupler member is threaded and is coupled to the mounting member by a nut that is threaded to the stud.

10. The drawbar assembly of claim 8, wherein the coupler member includes an eyelet for operably coupling the drawbar assembly to a vehicle.

11. The drawbar assembly of claim 8, further including:
at least one seal member located between the second end of the coupler member and the mounting member, the seal member preventing debris from entering the aperture of the mounting member.

12. The drawbar assembly of claim 11, wherein the at least one seal member comprises a pair of washers.

13. The drawbar assembly of claim 7, wherein the drawbar member includes a first portion and a second portion spaced from one another, and wherein the mounting member is fixedly coupled therebetween.

14. The drawbar assembly of claim 13, wherein the first and second portions of the drawbar member extending longitudinally and a spaced apart for a substantial length thereof.

15. The drawbar assembly of claim 13, wherein the first and second portions of the drawbar member each comprise hollow tubes.

16. The drawbar assembly of claim 15, wherein the first and second portion of the drawbar member each have a square-shaped cross-sectional configuration.

17. The drawbar assembly of claim 7, wherein the given amount of torque required to pivot the coupler member with respect to the mounting member is less than the amount of torque required to structurally damage the drawbar assembly.

18. The drawbar assembly of claim 7, further including:
a handle member extending upwardly from the drawbar member.

19. The drawbar assembly of claim 18, wherein the handle member is located approximately one quarter of a total length of the drawbar member for the second end of the drawbar member.

20. The drawbar assembly of claim 7, wherein the first end of the drawbar member includes an aperture for receiving an actuator arm of a brake assembly of a baggage cart.

21. The drawbar assembly of claim 7, wherein the first end of the drawbar member is adapted to pivotably couple to a cart and to pivot about a pivot axis, and wherein the pivot axis is located upwardly and forwardly of the aperture of the drawbar member adapted to receive an actuator arm of a brake assembly of a baggage cart.

22. The drawbar assembly of claim 7, further including:
a first portion of a piano hinge adapted to couple to a second portion of a piano hinge coupled to a cart.
